(19) United States
(12) Patent Application Publication
(10) Pub. No.: US 2015/0161684 A1
(43) Pub. Date: Jun. 11, 2015

(54) Multi-Sourced Charitable Contributions

(71) Applicant: FMR LLC, Boston, MA (US)

(72) Inventor: Ronald Raikula, Boston, MA (US)

(73) Assignee: FMR LLC, Boston, MA (US)

(21) Appl. No.: 14/102,389

(22) Filed: Dec. 10, 2013

(51) Int. Cl. G06Q 30/02; G06Q 20/10

(52) U.S. Cl. CPC G06Q 30/0279; G06Q 20/10

(57) ABSTRACT

Methods and apparatuses are described for making a charitable contribution. A server computing device receives a request to initiate a charitable contribution transaction from a mobile device, and the request includes a transaction identifier and a user identifier. The server computing device determines a plurality of characteristics associated with the charitable contribution transaction based upon the transaction identifier, and the plurality of characteristics including a contribution amount. The server computing device identifies a user based upon the user identifier. The server computing device charges a first portion of the contribution amount to a first account associated with the user and a second portion of the contribution amount to a second account associated with the user. The server computing device transmits payment instructions to a computing device associated with a recipient charity, and the payment instructions including the contribution amount.

### FIELD OF THE INVENTION

This application relates generally to methods and apparatuses, including computer program products, for making charitable contributions automatically from multiple funding sources associated with a donor.

### BACKGROUND

Traditionally, making charitable contributions has been a slow and inefficient process. Donors typically submit funds manually (e.g., via cash or check) and must keep track of their donations in order to complete their year-end accounting. While many charities have moved toward means to allow donors to submit contributions electronically, e.g., via a computing device utilizing the Internet to access a web site associated with the charity, the donor still does not have effective control over those source(s) from which the charitable donation is drawn. In addition, while computerized systems have emerged to allow a donor to manage his or her donations electronically, such systems are typically not linked to the systems by which the donor makes the donation.

### SUMMARY OF THE INVENTION

Therefore, what is needed are methods and systems to enable the initiation and execution of charitable contributions automatically via mobile computing devices, while sourcing the funds from multiple different sources associated with a donor. The methods and systems described herein allow for a donor to use his or her mobile device to initiate one or more donation transactions that link to multiple funding sources associated with the donor, including emergent funding sources like a charitable giving account. The methods and systems described herein also provide for pre-defined charity and charitable contribution information that is retrievable by the system for fast and accurate processing of the donation transaction(s), especially in regard to determining how to apportion the donation and determining the recipient(s) of the donation. Further, the methods and systems described herein provide the advantage of automatic execution of the donation transactions and recordation of the transactions (e.g., in a periodic report) for the donor's recordkeeping needs.

While the invention offers several advantages in terms of automatically processing charitable contributions to be deducted from multiple funding sources, and generating reports related to such contributions, the invention is not intended to result in any reduction, avoidance, or deferral of tax liability. Instead, the donor is responsible for the same tax liability as if he or she made the donations manually. The invention allows the donor to more efficiently make charitable donations that are automatically deducted from payment source(s) of the donor's choosing according to donation rules, and also allows the donor to track such donations through system-generated reports.

The invention, in one aspect, features a method for making a charitable contribution. A server computing device receives a request to initiate a charitable contribution transaction from a mobile device, and the request includes a transaction identifier and a user identifier. The server computing device determines a plurality of characteristics associated with the charitable contribution transaction based upon the transaction identifier, and the plurality of characteristics including a contribution amount. The server computing device identifies a user based upon the user identifier. The server computing device charges a first portion of the contribution amount to a first account associated with the user and a second portion of the contribution amount to a second account associated with the user. The server computing device transmits payment instructions to a computing device associated with a recipient charity, and the payment instructions including the contribution amount.

The invention, in another aspect, features a computerized system for making a charitable contribution. A system includes a server computing device configured to receive a request to initiate a charitable contribution transaction from a mobile device, and the request includes a transaction identifier and a user identifier. The server computing device is configured to determine a plurality of characteristics associated with the charitable contribution transaction based upon the transaction identifier, and the plurality of characteristics including a contribution amount. The server computing device is configured to identify a user based upon the user identifier. The server computing device is configured to charge a first portion of the contribution amount to a first account associated with the user and a second portion of the contribution amount to a second account associated with the user. The server computing device is configured to transmit payment instructions to a computing device associated with a recipient charity, and the payment instructions including the contribution amount.

The invention, in another aspect, features a computer program product, tangibly embodied in a non-transitory computer readable storage medium, for making a charitable contribution. The computer program product includes instructions operable to cause a data processing apparatus to receive a request to initiate a charitable contribution transaction from a mobile device, and the request includes a transaction identifier and a user identifier. The computer program product includes instructions operable to cause the data processing apparatus to determine a plurality of characteristics associated with the charitable contribution transaction based upon the transaction identifier, and the plurality of characteristics including a contribution amount. The computer program product includes instructions operable to cause the data processing apparatus to identify a user based upon the user identifier. The computer program product includes instructions operable to cause the data processing apparatus to charge a first portion of the contribution amount to a first account associated with the user and a second portion of the contribution amount to a second account associated with the user. The computer program product includes instructions operable to cause the data processing apparatus to transmit payment instructions to a computing device associated with a recipient charity, and the payment instructions including the contribution amount.

Any of the above aspects can include one or more of the following features. In some embodiments, the request to initiate a charitable contribution transaction is generated by the mobile device upon scanning a Quick Response (QR) code, a bar code, or a radio-frequency identification (RFID) tag. In some embodiments, the request to initiate a charitable contribution transaction is generated by an application executing on the mobile device. In some embodiments, determining a plurality of characteristics associated with the charitable contribution transaction includes retrieving, from a database, the plurality of characteristics based upon the transaction identifier.

In some embodiments, the user identifier includes a user name, an identifier associated with the mobile device, an identifier associated with an application executing on the mobile device, an identifier associated with an electronic wallet located on the mobile device, or any combination thereof. In some embodiments, the first account is a charitable giving account. In some embodiments, the second account is a bank account, a credit card account, a debit card account, or an electronic wallet account.

In some embodiments, the second portion of the contribution amount is associated with a receipt of tangible goods by the user. In some embodiments, charging the first portion of the contribution amount to the first account includes transmitting, to a computing device associated with the first account, instructions to debit the first portion of the contribution amount from the first account. In some embodiments, charging the second portion of the contribution amount to the second account includes transmitting, to a computing device associated with the second account, instructions to debit the second portion of the contribution amount from the second account.

In some embodiments, the server computing device periodically generates a report including a list of charitable contribution transactions associated with the user identifier, and transmits the report to the user. In some embodiments, the request includes electronic authorization credentials associated with the user. In some embodiments, the payment instructions include identification of the first portion of the contribution amount and identification of the second portion of the contribution amount. In some embodiments, the payment instructions include identification of the user. In some embodiments, the payment instructions include the transaction identifier.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A is a block diagram of a system for making a charitable contribution, according to an embodiment of the invention.

FIG. 1B is a block diagram of a system for making a charitable contribution, according to an embodiment of the invention.

FIG. 2 is a flow diagram of a method for making a charitable contribution, according to an embodiment of the invention.

FIG. 3 is a transactional diagram of a method for making a charitable contribution.

FIG. 4 is a transactional diagram of a method for making a charitable contribution.

FIG. 5 is a block diagram of a networked system for making a charitable contribution.

### DETAILED DESCRIPTION

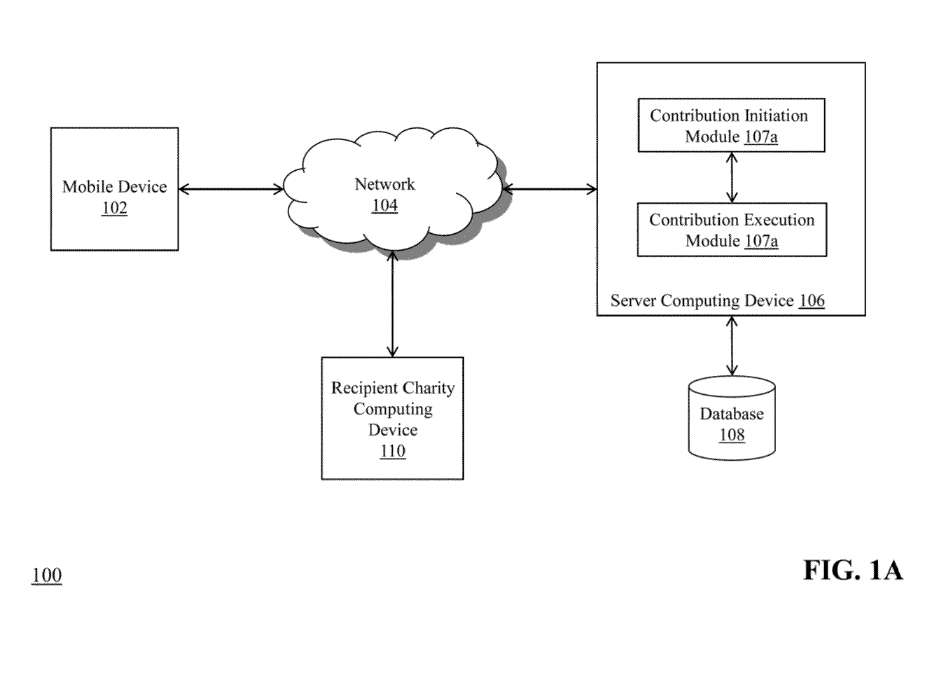

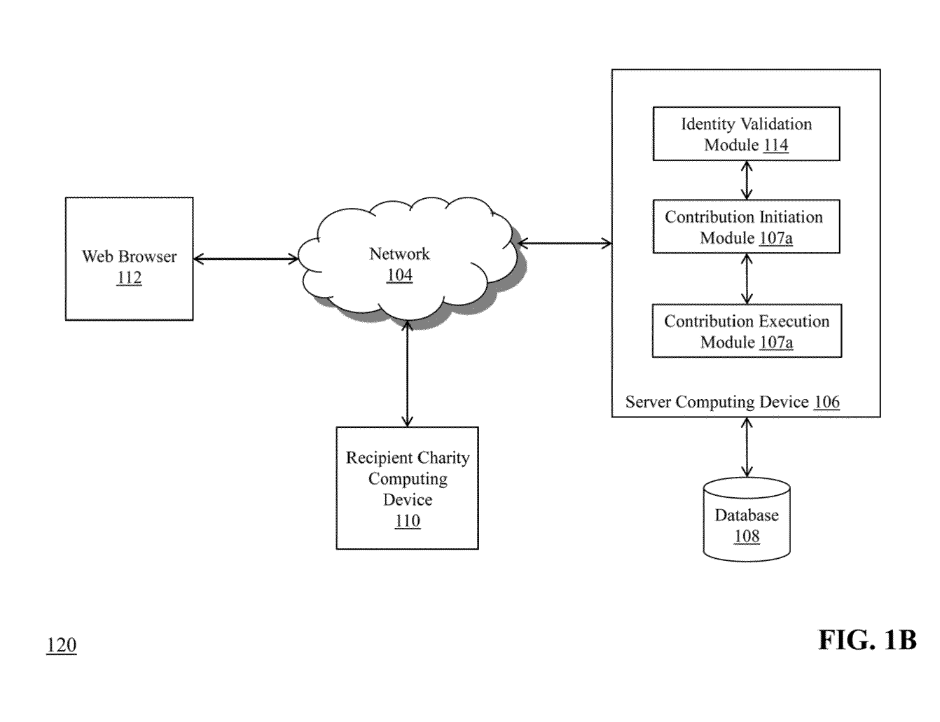

FIG. 1A is a block diagram of a system 100 for making a charitable contribution. The system 100 includes a mobile computing device 102, a communications network 104, a server computing device 106, a database 108, and a recipient charity computing device 110. The computing devices implement the computer processing in accordance with computer-implemented embodiments of the invention. The methods described herein may be achieved by implementing program procedures, modules and/or software executed on, for example, a processor-based computing devices or network of computing devices.

The mobile computing device 102 connects to the server computing device 106 via the network 104 to initiate a charitable contribution transaction. Exemplary mobile computing devices take on many forms, including but not limited to a laptop computer, a tablet computer, a smart phone, an internet appliance, or the like. Although FIG. 1A depicts a mobile computing device, it should be appreciated that other computing devices (e.g., a desktop computer) can be used without departing from the scope of the invention. The mobile computing device 102 includes network-interface components to connect to a communications network 104. In some embodiments, the network-interface components include components to connect to a wireless network, such as a Wi-Fi or cellular network, in order to access a wider network, such as the Internet. The mobile computing device 102 also includes software (e.g., a web browsing application) to navigate to an address associated with the server computing device 106, view content received from the server computing device 106, and provide input that is transmitted to the server computing device 106, for the purposes of initiating and executing a charitable contribution transaction.

In some embodiments, the mobile computing device 102 also includes image-capture components such as a camera to read or scan images—such as barcodes, QR codes, and the like—in order to initiate the contribution transaction. In some embodiments, the mobile computing device 102 includes components to interact with other devices via a short-range frequency (e.g., Bluetooth, RFID, NFC) in order to initiate and/or execute a charitable contribution transaction. In some embodiments, the mobile computing device 102 includes a software application to store a user's financial information (e.g., a mobile wallet) locally on the mobile device 102, the financial information to be used as part of the charitable contribution transaction. In some embodiments, the mobile computing device 102 includes a software application to authenticate the mobile device 102 to the server computing device 102 before or during execution of the charitable contribution transaction.

The communications network 104 sends communications from the mobile computing device 102 to the server computing device 106 and back. The network 104 may be a local network, such as a LAN, or a wide area network, such as the Internet and/or a cellular network.

The server computing device 106 includes a contribution initiation module 107a and a contribution execution module 107b. The contribution initiation module 107a and contribution execution module 107b are hardware and/or software modules located in the server computing device 106 and used to execute the method for making a charitable contribution described herein. In some embodiments, the functionality of the contribution initiation module 107a and contribution execution module 107b is distributed among a plurality of computing devices. It should be appreciated that any number of computing devices, arranged in a variety of architectures, resources, and configurations (e.g., cluster computing, virtual computing, cloud computing) can be used without departing from the scope of the invention.

The database 108 is coupled to the server computing device 106, and stores data associated with the charitable contribution transaction, such as characteristics of the donor and the donor's associated funding sources, the recipient charity, and the donation transaction, among other things. In some embodiments, the database 108 resides on a separate computing device from the server computing device 106. In some embodiments, the database 108 is integrated into the server computing device 106. Although FIG. 1A depicts a single database 108, it should be appreciated that multiple databases can be used (e.g., for financial/funding information, for charity information, for donation information) without departing from the scope of the invention.

In some embodiments, a user at a mobile computing device (e.g., device 102) can interact with the system 100 by opening a Web browser on the mobile device 102 and entering the address of the server computing device 106. The user can log in to the server 106 by providing credentials to the Web browser. The credentials can include, for example, one or more of the following: a username, user ID, password, personal identification number (PIN), certificate, pass code, encryption key, or other similar authentication data. For example, the server 106 receives a request from the mobile device 102 to initiate a charitable contribution using an application associated with contribution initiation module 107a and contribution execution module 107b, where the request contains the credentials. The server computing device 106 authenticates the user by comparing the credentials in the request with pre-stored credential information. Once the server computing device 106 authenticates the user, the server computing device 106 enables the user to access the contribution initiation module 107a and contribution execution module 107b. The contribution initiation module 107a and contribution execution module 107b can be elements of a web-based application, implemented using HTML, XML, JavaScript, or other similar software development platforms, that receives inputs from the mobile device 102 and processes the inputs in a fully automated manner to make a charitable contribution, according to the methods described herein. The contribution initiation module 107a and contribution execution module 107b also generate user interface data as part of the charitable contribution process, and transmit a user interface based on the user interface data to the mobile device 102 for display to the user.

FIG. 1B is a block diagram of a system 120 for making a charitable contribution. The system 120 is similar to the system 100 of FIG. 1A, and includes a web browser 112 (e.g., running on a computing device) and an identity validation module 114 in addition to the communications network 104, the server computing device 106, the database 108, and the recipient charity computing device 110 as described above with respect to FIG. 1A. It should be appreciated that the components set forth in FIGS. 1A and 1B can be combined to arrive at any number of different configurations without departing from the scope of the invention.

The identity validation module 114 (as shown in FIG. 1B) is a hardware and/or software module located in the server computing device 106 and used to execute the method for making a charitable contribution described herein. The identity validation module 114, for example, stores information about a user of the system and, in some cases, information about the payment methodology (e.g., electronic wallet) associated with the user.

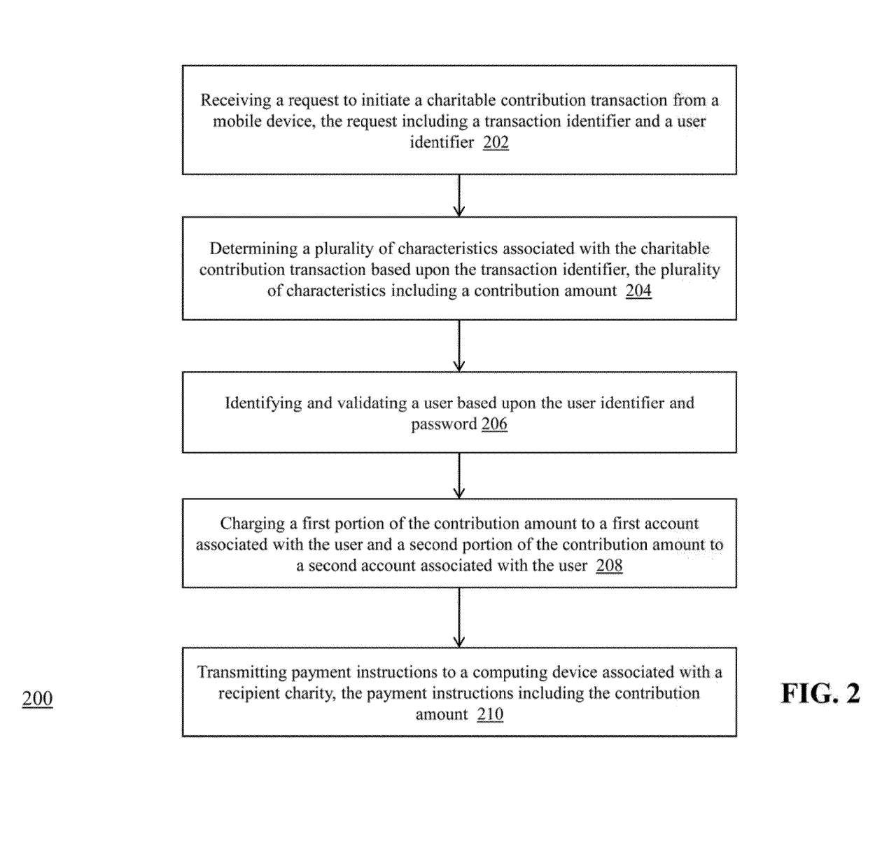

FIG. 2 is a flow diagram of a method 200 for making a charitable contribution, using the system 100 of FIG. 1A and/or the system 120 of FIG. 1B. The server computing device 106 receives (202) a request to initiate a charitable contribution from the mobile device 102. For example, a user may notice a poster advertising a charity that is seeking donations. The poster may include a barcode or QR code to be scanned or read by mobile devices in order to make a donation to the charity. The user can read the barcode with the mobile device 102, and the mobile device 102 transmits a request to initiate a charitable contribution to the server computing device 106. The request includes data associated with the barcode (e.g., a transaction identifier) and data associated with the user of the mobile device 102 (e.g., a user identifier).

In another example, the poster may include a URL to the charity's website, where the URL includes a special string of characters associated with the charity and/or the specific donation transaction (e.g., a transaction identifier). Upon entering the URL into a web browsing application on the mobile device 102 (or the web browser 112 of FIG. 1B), the mobile device 102 transmits a request to initiate a charitable contribution to the server computing device 106. The server computing device 106 can present a user interface on the mobile device 102 that requests authentication information or other credentials (e.g., a user identifier) from the user in order to initiate the charitable contribution transaction. In some embodiments, the mobile device 102 automatically transmits authentication and/or authorization information as part of the request to initiate the contribution transaction.

In some embodiments, the request to initiate a charitable contribution can be initiated by, e.g., viewing a web page at the web browser 112 of FIG. 1B. The web page can include a QR code, link, or other mechanism for initiating the charitable contribution. A user can interact with the QR code or link, e.g., by clicking it, and the user identifier (such as user id and/or password) and the donation identifier are transmitted by the web browser 112 to the server computing device 106. In this example, a mobile device is not required to initiate the charitable contribution; instead, a computing device with a web browser is sufficient to begin the process described herein.

Upon receiving the request to initiate a charitable contribution transaction, the server computing device 106, via the contribution initiation module 107a, determines (204) a plurality of characteristics associated with the charitable contribution transaction based upon the transaction identifier that was included in the request. In some embodiments, the contribution initiation module 107a uses the transaction identifier to retrieve the plurality of characteristics from one or more databases (e.g., database 108). The plurality of characteristics can include information about the recipient charity (e.g., name, ID number, payment instructions, charity status, and the like).

The plurality of characteristics can include information about the donation transaction(s) relating to the transaction identifier, such as donation amount, eligibility status, marketing information, receipt of goods/services in exchange for the donation, and the like). The transaction identifier can relate to one or more donation transactions that are part of the overall charitable contribution transaction. For example, a charitable contribution transaction can consist of multiple underlying donation transactions—such as a donation of $200 from the donor in exchange for theater tickets with a value of $50. In some cases, the donor would be able to deduct only $150 of the total $200 donation due to his receipt of an item worth $50 as part of the contribution. The database 108 stores all of the information associated with the overall contribution transaction (e.g., total donation amount, value of tickets, eligibility constraints) for retrieval and use by the server computing device 106.

The contribution initiation module 107a identifies (206) and validates a user based upon the user identifier (and in some cases, a password) that was received as part of the request from the mobile device 102. In some embodiments, the user identifier is a username, authentication credentials entered by the user, or other similar information useful in identifying the user. The contribution initiation module 107a can look up personal and/or financial account information associated with the user based upon the user identifier. For example, the contribution initiation module 107a can retrieve the user's mailing address, phone number, email address, and the like based upon the user identifier. In another example, the contribution initiation module 107a can retrieve the user's financial account information based upon the user identifier, if the user has elected to store such financial information in the system 100 or allow the system 100 to have access to such financial information that is stored in other computing systems or devices. In some embodiments, the identity validation module 114 of FIG. 1B is used to verify the user's identity by, e.g., retrieving user information from database 108 and authenticating the user information against the user identifier.

In some embodiments, the user identifier is financial account information stored on the mobile device 102 (e.g., a mobile wallet) and transmitted to the server computing device 106 as part of the request. For example, the request to initiate the charitable contribution transaction can be made by a mobile wallet application residing on the mobile device 102. The mobile wallet application contains financial account information associated with the user of the mobile device. The mobile wallet application authenticates to the server computing device 102 and transmits the financial account information via a secure, encrypted connection to the server computing device 106. In this embodiment, the server computing device 106 does not have to retrieve or store financial account information associated with the user, as the information is provided by the mobile device 102 as part of the transaction. The server computing device 106 can still use the financial account information to identify the user (e.g., by retrieving personal information of the user based upon a lookup of the financial account information in a database maintained by a financial institution that services the financial account). In some embodiments, the user's financial information is stored, e.g., at the server computing device 106 and/or at the database 108.

The financial account information referenced above can include a plurality of funding sources to be used by the server computing device 106 in processing the charitable contribution transaction. The financial account information can include bank account information (e.g., account/routing numbers), credit card and/or debit card account information, charitable giving account information, investment account information, and other similar payment accounts and methods. The server computing device 106 can maintain information associated with any number of financial accounts held by the user, to be used in funding the charitable contribution transaction.

The server computing device, via the contribution execution module 107b, charges (208) a first portion of the contribution amount to a first account associated with the user and a second portion of the contribution amount to a second account associated with the user. Typically, the contribution amounts are deducted from accounts based upon, e.g., user preferences and/or requirements and limitations on the accounts from which the contribution amounts are being sourced. For example, the contribution initiation module 107a retrieves donation information associated with the contribution transaction and determines that the total contribution amount is $200 and the user is to receive theater tickets worth $50 in exchange for the contribution. The contribution initiation module 107a determines that, based upon the user's preferences, the contribution amount should be deducted from his charitable giving account and then from his credit card account. However, the charitable giving account is subject to certain restrictions that limit payments from the account to only certain eligible contributions. Based on this analysis, the contribution execution module 107b determines that $150 of the above contribution amount is eligible and proceeds to charge that portion of the contribution amount to the user's charitable giving account. The contribution execution module 107b then charges the remaining $50 that is not eligible (e.g., due to the receipt of theater tickets) to the user's credit card account.

In another example, the contribution amount may be too small to be eligible for deduction from the user's charitable giving account or the recipient charity may not be eligible to receive donations from the user's charitable giving account. In these cases, the contribution execution module 107b can quickly and efficiently deduct the appropriate amount(s) from alternative funding sources provided by the user.

It should be appreciated that the contribution amount can be charged to more than two funding sources and to multiple funding sources of the same type. For example, the user may want to source non-eligible contributions evenly between his credit card account and his electronic wallet account, while maintaining eligible contributions from his charitable giving account. In another example, the contribution execution module 107b can split a contribution amount between several credit card accounts, based upon the user's preferences and/or the requirements of the charity or the particular donation transaction(s).

The server computing device 106, via the contribution execution module 107b, transmits (210) payment instructions to a computing device associated with the recipient charity (e.g., recipient charity computing device 110 in FIG. 1A and/or FIG. 1B). The payment instructions include the contribution amount and, in some embodiments, information about the donor and/or the financial account from which the contribution amount is being sourced.

The contribution execution module 107b also records the donation transactions associated with the overall charitable contribution transaction in a database (e.g., database 108) and periodically generates reports to be transmitted to the user for recordkeeping and year-end accounting preparation purposes. In some embodiments, the contribution execution module 107b transmits the donation transaction information to a software program or service, either automatically or at the request of the user.

Use Case 1

The following is an example use case for making a charitable contribution according to the system and method described in FIGS. 1 and 2 above.

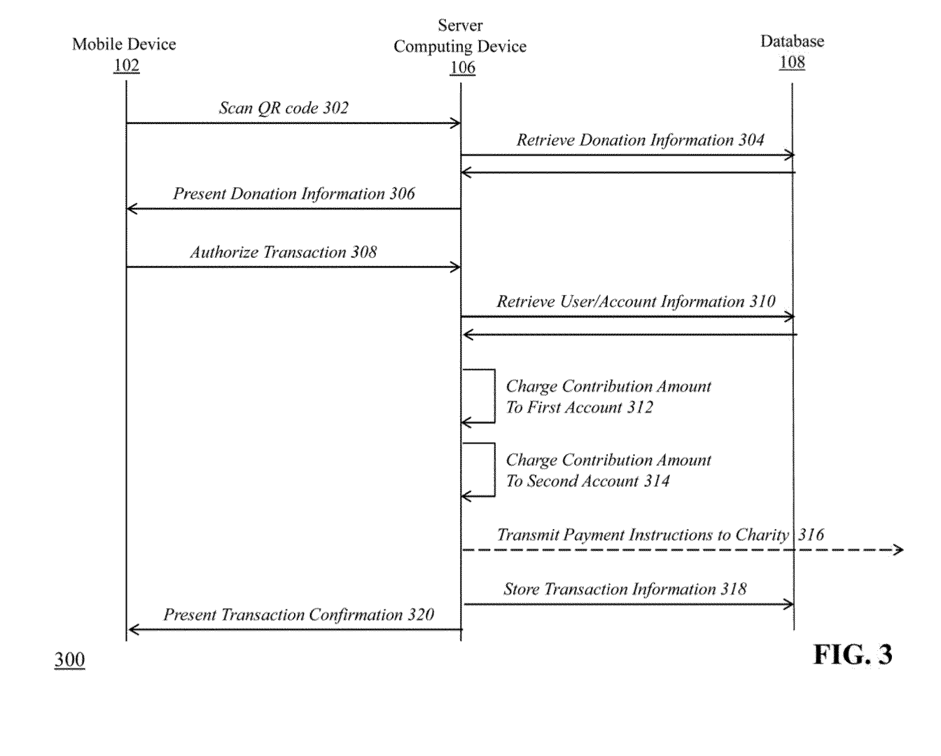

FIG. 3 is a transactional diagram of a method for making a charitable contribution. A user with a mobile device 102 (e.g., a smart phone) is presented with a card, poster, or other similar marketing item associated with making a monetary donation to a charity. The marketing item describes the details of the donation and includes, e.g., a QR code that is scannable or readable by the user's mobile device 102. The QR code includes embedded information relating to the donation (e.g., transaction identifier). Upon scanning the QR code (302), the mobile device 102 transmits a request to initiate the donation transaction to the server computing device 106. The server computing device 106, via the contribution initiation module 107a, retrieves (304) donation information (e.g., amount, recipient, marketing channel) from the database 108 by using the transaction identifier. The contribution initiation module 107a presents (306) the donation information to the user via a user interface on the mobile device 102. The user provides input to the mobile device 102 to authorize the transaction, and the mobile device 102 transmits an authorization for the transaction (308) to the server computing device 106. For example, the user can enter credentials via the user interface and click a ‘submit’ button to authorize the transaction. In another example, the user's credentials are stored on the mobile device 102 and automatically transmitted to the server computing device 106 as part of the authorization.

The server computing device 106, via the contribution initiation module 107a, retrieves (310) user information and/or financial account information associated with the user, to be used in processing the donation transaction. The server computing device 106, via the contribution execution module 107b, charges (312) a portion of the contribution amount to a first account of the user and charges (314) a portion of the contribution amount to a second account of the user. The contribution execution module 107b transmits (316) payment instructions associated with the donation transaction to a computing device (e.g., device 110) associated with the recipient charity. The contribution execution module 107b stores (318) transaction information associated with the donation for, e.g., later retrieval and reporting to the user. The contribution execution module 107b presents (320) a confirmation of the donation transaction to the user via a user interface on the mobile device 102.

Use Case 2

The following is another example use case for making a charitable contribution according to the system and method described in FIGS. 1 and 2 above.

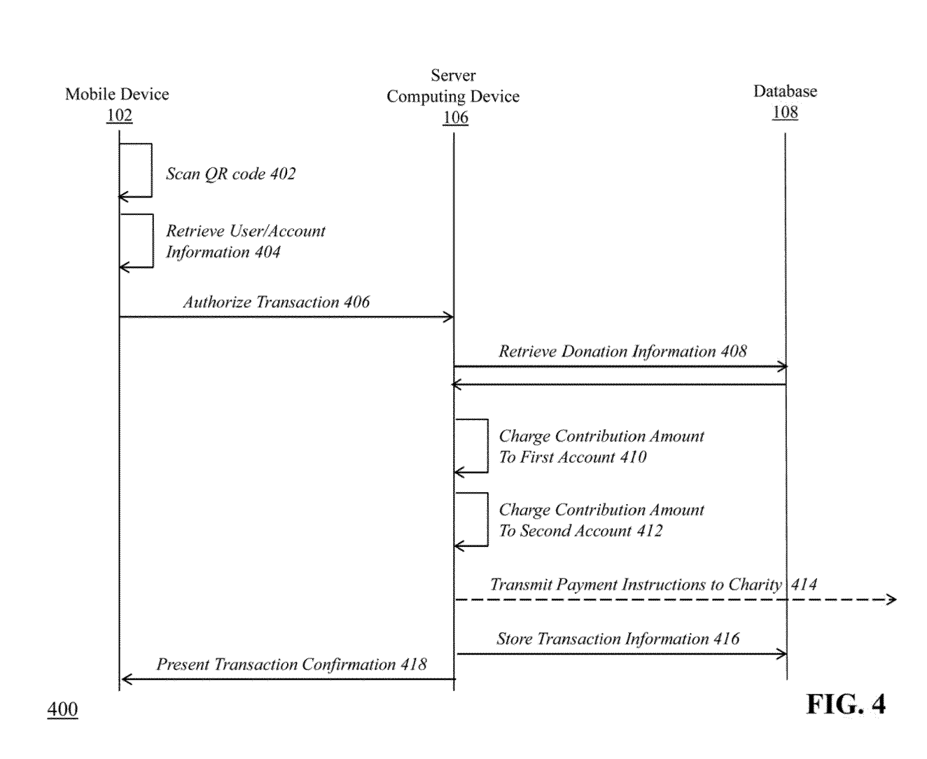

FIG. 4 is a transactional diagram of another method for making a charitable contribution. A user with a mobile device 102 (e.g., a smart phone) is presented with a card, poster, or other similar marketing item associated with making a monetary donation to a charity. The marketing item describes the details of the donation and includes, e.g., a QR code that is scannable or readable by the user's mobile device 102. The QR code includes embedded information relating to the donation (e.g., transaction identifier). Upon scanning the QR code (402), the mobile device 102 retrieves (404) user information and/or financial account information from a mobile wallet application located on the mobile device 102. In some embodiments, the mobile wallet application retrieves data stored locally on the mobile device 102. In some embodiments, the mobile wallet application retrieves data from a remote computing device (e.g., a server computing device that maintains the user's mobile wallet information) via network 104.

The mobile device 102 then transmits a request to initiate the donation transaction to the server computing device 106, including authorization for the transaction and a transaction identifier obtained from the QR code (406). The server computing device 106, via the contribution initiation module 107a, retrieves (408) donation information (e.g., amount, recipient, marketing channel) from the database 108 by using the transaction identifier. The server computing device 106, via the contribution execution module 107b, charges (410) a portion of the contribution amount to a first account of the user and charges (412) a portion of the contribution amount to a second account of the user. The contribution execution module 107b transmits (414) payment instructions associated with the donation transaction to a computing device (e.g., device 110) associated with the recipient charity. The contribution execution module 107b stores (416) transaction information associated with the donation for, e.g., later retrieval and reporting to the user. The contribution execution module 107b presents (418) a confirmation of the donation transaction to the user via a user interface on the mobile device 102.

The techniques described herein are particularly advantageous when applied in the context of a charitable giving account/fund. For example, the financial institution that manages and oversees a user's charitable giving account can pre-screen potential recipient charities and provide encoded grant requests (e.g., QR codes, barcodes) for distribution to donors. The encoded grant requests can be pre-authorized with the system 100 to permit automated approval (i.e., no manual authorization or approval required from the donor) and/or a lower minimum grant threshold. The financial institution can provide a consolidated giving report to the donor, showing deductible and non-deductible contributions, both inside and outside of the donor's charitable giving account, over a period of time, thereby making end-of-year accounting much easier.

For donors that may not hold a charitable giving account, the financial institution can offer an application for mobile devices that still allow a donor to register with the system 100 and initiate contribution transactions to charities that may be associated with the charitable giving account, but instead source the contribution from alternative payment methods (e.g., credit card, debit card). The result is a simpler, easier method of donating (thus encouraging more people to donate, even those without a charitable giving account). These donors can also receive access to the periodic reports and other tracking features of the system 100 upon registering, even if they do not have a charitable giving account.

In addition, the system 100 can offer donors a ‘just-in-time’ charitable giving account upon their first use of the system, if they do not have a charitable giving account. For example, upon initiating a charitable contribution transaction via a mobile device, the server computing device 106 can determine that the initiating user is not associated with a charitable giving account. The server computing device 106 can charge the contribution amount to an alternative funding source (e.g., a credit card), allocate those funds into a new charitable giving account, and then distribute the funds from the charitable giving account to the recipient charity.

Also, payment of charitable contributions from a charitable giving account can limit or avoid certain fees imposed on either the charity and/or the donor when making a contribution. For example, the charity may incur a processing fee (e.g., credit card merchant fee) when receiving a donation that is paid for by the donor using a credit card. The system 100 can source the funds from a charitable giving account instead of the credit card, and thereby avoid the merchant fee—which results in the charity receiving more of the total intended donation amount.

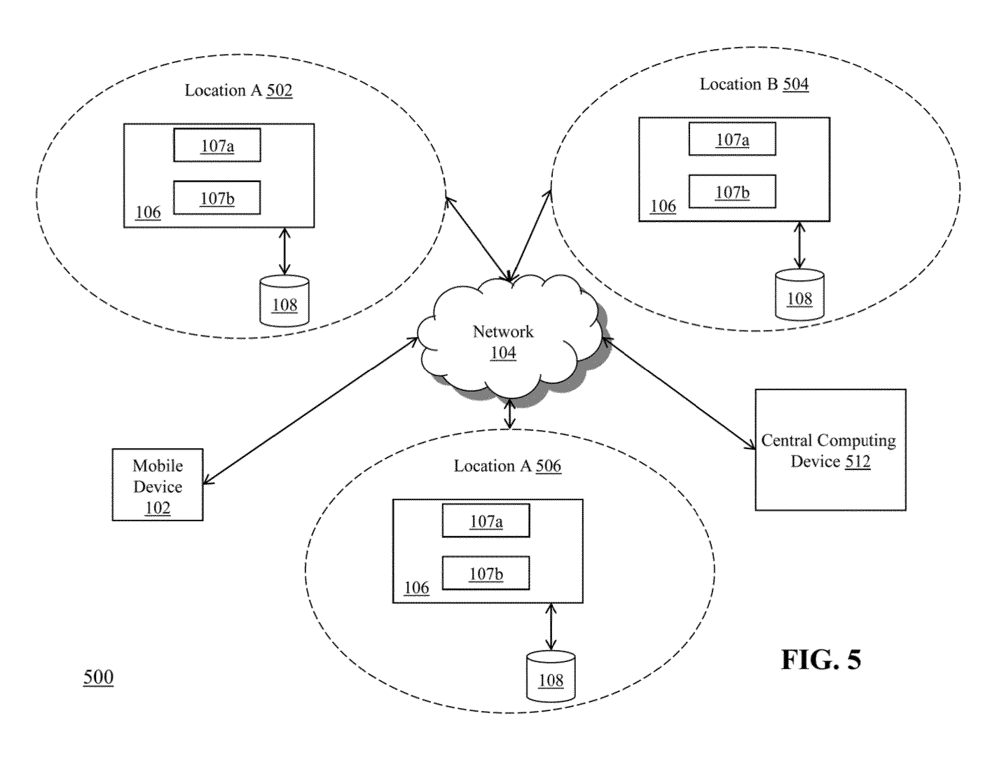

The techniques may be implemented in a networked system 500 comprising multiple computing devices distributed across different locations, as shown in FIG. 5. Each of Location A 502, Location B 504 and Location C 506 includes the server computing device 106 having components 107a, 107b, 108 of FIGS. 1A and/or 1B, and the servers at locations 502, 504, and 506 are connected to each other via the network 104. The networked system of FIG. 5 enables distribution of the processing functions described herein across several computing devices and provides redundancy in the event that a computing device at one location is offline or inoperable. In some embodiments, mobile computing devices (e.g., device 102a) in proximity to a particular location (e.g., Location A 502) access the networked system via the server 106 at that location. In some embodiments, the server computing devices 106 at the respective locations 502, 504, 506 communicate with a central computing device 512 (e.g., a server) that is coupled to the network. The central computing device 512 can provide data and/or processing resources for the network of computing devices 106 (e.g., synchronization of functionality/data across the computing devices).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A computerized method for making a charitable contribution, the method comprising:
scanning, by a reader coupled to a mobile device, a barcode;
converting, by an application executing on the mobile device, the barcode into a transaction identifier associated with a charitable contribution transaction;
generating, by the application executing on the mobile device, a request to initiate the charitable contribution transaction, the request including the transaction identifier and a user identifier stored on the mobile device that is different from the transaction identifier;
receiving, by a server computing device, the request to initiate the charitable contribution transaction from the mobile device;
determining, by the server computing device, a plurality of characteristics associated with the charitable contribution transaction from a database of pre-encoded charitable contribution transactions based upon the transaction identifier, the plurality of characteristics including a predefined contribution amount and a processing fee amount to be deducted from the predefined contribution amount;
identifying, by the server computing device, a user based upon the user identifier;
determining, by the server computing device, whether the user is associated with an existing charitable giving account;
automatically establishing, by the server computing device, a charitable giving account for the user if the user is not associated with an existing charitable giving account;
automatically approving, by the server computing device, the charitable contribution transaction without requiring donor authorization;
charging, by the server computing device, a first portion of the contribution amount to a first account associated with the user and a second portion of the contribution amount to a second account associated with the user, wherein the first account is not a charitable giving account;
depositing, by the server computing device, the first portion of the contribution amount into the charitable giving account; and
transmitting, by the server computing device, payment instructions to a computing device associated with a recipient charity, the payment instructions including instructions to debit the first portion of the contribution amount from the newly-established charitable giving account and instructions to waive the processing fee amount if the processing fee amount is greater than zero.

2. The method of claim 1, wherein the request to initiate a charitable contribution transaction is generated by the mobile device upon scanning a Quick Response (QR) code, a bar code, or a radio-frequency identification (RFID) tag.

3-4. (canceled)

5. The method of claim 1, wherein the user identifier is an identifier associated with an electronic wallet located on the mobile device.

6. (canceled)

7. The method of claim 1, wherein the first account is a bank account, a credit card account, a debit card account, or an electronic wallet account and the second account is a bank account, a credit card account, a debit card account, or an electronic wallet account.

8. The method of claim 1, wherein the second portion of the contribution amount is associated with a receipt of tangible goods by the user.

9. The method of claim 1, wherein charging the first portion of the contribution amount to the first account includes transmitting, to a computing device associated with the first account, instructions to debit the first portion of the contribution amount from the first account.

10. The method of claim 1, wherein charging the second portion of the contribution amount to the second account includes transmitting, to a computing device associated with the second account, instructions to debit the second portion of the contribution amount from the second account.

11. The method of claim 1, further comprising:
periodically generating, by the server computing device, a report including a list of charitable contribution transactions associated with the user identifier; and
transmitting, by the server computing device, the report to the user.

12. The method of claim 1, wherein the request includes electronic authorization credentials associated with the user.

13. The method of claim 1, wherein the payment instructions include identification of the first portion of the contribution amount and identification of the second portion of the contribution amount.

14. The method of claim 1, wherein the payment instructions include identification of the user.

15. The method of claim 1, wherein the payment instructions include the transaction identifier.

16. A computerized system for making a charitable contribution, the system comprising a server computing device configured to:
receive a request to initiate a charitable contribution transaction from a mobile device, the request including a transaction identifier and a user identifier stored on the mobile device that is different from the transaction identifier and is generated by an application executing on the mobile device;
determine a plurality of characteristics associated with the charitable contribution transaction from a database of pre-encoded charitable contribution transactions based upon the transaction identifier, the plurality of characteristics including a predefined contribution amount and a processing fee amount to be deducted from the predefined contribution amount;
identify a user based upon the user identifier;
automatically establish a charitable giving account for the user if the user is not associated with an existing charitable giving account;
automatically approve the charitable contribution transaction without requiring donor authorization;
charge a first portion of the contribution amount to a first account associated with the user and a second portion of the contribution amount to a second account associated with the user, wherein the first account is not a charitable giving account;
deposit the first portion of the contribution amount into the charitable giving account; and
transmit payment instructions to a computing device associated with a recipient charity, the payment instructions including instructions to debit the first portion of the contribution amount from the newly-established charitable giving account and instructions to waive the processing fee amount if the processing fee amount is greater than zero.

17. The system of claim 16, wherein the request to initiate a charitable contribution transaction is generated by the mobile device upon scanning a Quick Response (QR) code, a bar code, or a radio-frequency identification (RFID) tag.

18-19. (canceled)

20. The system of claim 16, wherein the user identifier is an identifier associated with an electronic wallet located on the mobile device.

21. (canceled)

22. The system of claim 16, wherein the first account is a bank account, a credit card account, a debit card account, or an electronic wallet account and the second account is a bank account, a credit card account, a debit card account, or an electronic wallet account.

23. The system of claim 16, wherein the second portion of the contribution amount is associated with a receipt of tangible goods by the user.

24. The system of claim 16, wherein charging the first portion of the contribution amount to the first account includes transmitting, to a computing device associated with the first account, instructions to debit the first portion of the contribution amount from the first account.

25. The system of claim 16, wherein charging the second portion of the contribution amount to the second account includes transmitting, to a computing device associated with the second account, instructions to debit the second portion of the contribution amount from the second account.

26. The system of claim 16, the server computing device further configured to:
periodically generate a report including a list of charitable contribution transactions associated with the user identifier; and
transmit the report to the user,

27. The system of claim 16, wherein the request includes electronic authorization credentials associated with the user.

28. The system of claim 16, wherein the payment instructions include identification of the first portion of the contribution amount and identification of the second portion of the contribution amount.

29. The system of claim 16, wherein the payment instructions include identification of the user.

30. A computer program product, tangibly embodied in a non-transitory computer readable medium, for making a charitable contribution, the computer program product including instructions operable to cause a data processing apparatus to:
receive a request to initiate a charitable contribution transaction from a mobile device, the request including a transaction identifier and a user identifier stored on the mobile device that is different from the transaction identifier and is generated by an application executing on the mobile device;
determine a plurality of characteristics associated with the charitable contribution transaction from a database of pre-encoded charitable contribution transactions based upon the transaction identifier, the plurality of characteristics including a predefined contribution amount and a processing fee amount to be deducted from the predefined contribution amount;
identify a user based upon the user identifier;
automatically establish a charitable giving account for the user if the user is not associated with an existing charitable giving account;
automatically approve the charitable contribution transaction without requiring donor authorization;
charge a first portion of the contribution amount to a first account associated with the user and a second portion of the contribution amount to a second account associated with the user, wherein the first account is not a charitable giving account;
deposit the first portion of the contribution amount into the charitable giving account; and
transmit payment instructions to a computing device associated with a recipient charity, the payment instructions including instructions to debit the first portion of the contribution amount from the newly-established charitable giving account and instructions to waive the processing fee amount if the processing fee amount is greater than zero.

31. The method of claim 1, further comprising:
receiving, by the server computing device, charitable contribution data from the recipient charity;
prescreening, by the server computing device, the recipient charity based upon the charitable contribution data to determine the charity's eligibility to receive donations; and
generating, by the server computing device, pre-encoded charitable contribution transactions using the charitable contribution data if the charity is eligible to receive donations.

32. The system of claim 16, wherein the server computing device is further configured to:
receive charitable contribution data from the recipient charity;
prescreen the recipient charity based upon the charitable contribution data to determine the charity's eligibility to receive donations; and
generate pre-encoded charitable contribution transactions using the charitable contribution data if the charity is eligible to receive donations.
